(19) United States
(12) Patent Application Publication
(10) Pub. No.: US 2023/0316889 A1
(43) Pub. Date: Oct. 5, 2023

(54) MONITORING SYSTEM AND STORAGE MEDIUM

(71) Applicant: HONDA MOTOR CO., LTD., Tokyo (JP)

(72) Inventor: Hodaka Mukohara, Tokyo (JP)

(21) Appl. No.: 18/119,307

(22) Filed: Mar. 9, 2023

(30) Foreign Application Priority Data
Mar. 31, 2022 (JP) 2022-059301

(51) Int. Cl. G08B 21/04; G08B 21/02; G06V 40/16

(52) U.S. Cl. CPC G08B 21/0476; G08B 21/0269; G08B 21/0263; G06V 40/172

(57) ABSTRACT

A monitoring system includes an identification unit configured to identify a person to be monitored, a first position information acquisition unit configured to acquire position information about the person to be monitored, a notification unit configured to detect that the person to be monitored enters a predetermined range and notify a terminal of a monitor person of the person to be monitored entering the predetermined range, a data storage section configured to store an image of the person to be monitored captured within the predetermined range with the terminal by the monitor person who receives the notification so as to be capable of providing to an identifying person who identifies the person to be monitored, and a processing unit capable of providing an image of the person to be monitored to the identifying person who identifies the person to be monitored.

### CROSS-REFERENCE TO RELATED APPLICATION

Priority is claimed on Japanese Patent Application No. 2022-059301, filed in Japan on Mar. 31, 2022, the entire content of which is incorporated herein by reference.

### BACKGROUND OF THE INVENTION

### Field of the Invention

The present invention relates to a monitoring system and a storage medium.

### Description of Related Art

A watching system in consideration of privacy has been proposed. In this system, the person to be watched has a radio tag, features of the clothes imaged by the camera at the entrance when the person leaves home is extract, and whether the image captured and transmitted by the supporter includes the features of the clothes of the person to be watched is checked. In this system, in order to emphasize privacy, a picture of a person to be monitored is not disclosed to a supporter, and the supporter images a person in need, a lost child, a person wandering, or the like (see, for example, Japanese Unexamined Patent Application, First Publication No. 2020-181344).

The system for guiding a parent to a position of a child who gets lost in a facility without registering personal information has been proposed. In this system, parent-child recognition or the like is performed when they enter a facility, and the parent inputs lost information from his/her terminal, and a lost child is detected on the basis of an image captured by a camera in the facility (see, for example, Japanese Unexamined Patent Application, First Publication No. 2013-191059).

### SUMMARY OF THE INVENTION

However, in the technique described in Japanese Unexamined Patent Application, First Publication No. 2020-181344, since the person to be watched is not identified, it is not possible to watch a specific person. The technique described in Japanese Unexamined Patent Application, First Publication No. 2013-191059 is a system used in a facility and is a system in which a camera installed in the facility captures an image, and a supporter is not involved.

An aspect according to the present invention has been made in view of the above problems, and an object of the present invention is to provide a monitoring system and a storage medium that enable a monitor person to monitor an identified person to be monitored and provide a monitoring result to the identifying person.

In order to solve the above-described problems and achieve the object, the present invention adopts the aspects described below.

(1) A monitoring system according to an aspect of the present invention includes an identification unit configured to identify a person to be monitored, a first position information acquisition unit configured to acquire position information about the person to be monitored, a notification unit configured to detect that the person to be monitored enters a predetermined range and notify a terminal of a monitor person of the person to be monitored entering the predetermined range, a data storage section configured to store an image of the person to be monitored captured within the predetermined range with the terminal by the monitor person who receives the notification so as to be capable of providing to an identifying person who identifies the person to be monitored, and a processing unit capable of providing an image of the person to be monitored to the identifying person who identifies the person to be monitored.

According to (1), the identifying person can grasp the situation of the person to be monitored through the image captured by the monitor person.

(2) In the above (1), the processing unit may be capable of providing an image of the person to be monitored to a permitted person who is permitted, by the identifying person, to share a situation of the person to be monitored.

According to (2), for example, it is possible for the grandfather, the grandmother, and the like to view the image, and thus it is possible to confirm the image, for example, when the identifying person is absent.

(3) In the above (1) or (2), the monitoring system may further include a second position information acquisition unit configured to acquire position information about the monitor person, wherein the notification unit may not make a notification to the terminal of the monitor person when the monitor person does not stay in the predetermined range on the basis of a result acquired by the second position information acquisition unit.

According to (3), since the notification is not received when the monitor person is outside the predetermined range, the notification at the timing at which the monitor person cannot perform imaging can be eliminated, and the convenience of the monitor person is improved.

(4) In the above (1) or (2), the monitoring system may not make a notification to the terminal of the monitor person when the person to be monitored does not stay in the predetermined range.

According to (4), since the notification is not received when the monitor person is out of the predetermined range, the convenience of the monitor person is improved.

(5) In any one of the above (1) to (4), the processing unit may perform an image process on the image to a level at which an image of a person other than the person to be monitored is not possible to be discriminated, and provide the image to the identifying person.

According to (5), it is possible to protect privacy of persons other than the person to be monitored.

(6) In any one of (1) to (5), the notification unit may not make a notification to the terminal of the monitor person in a time other than a predetermined time even when the person to be monitored is in the predetermined range.

According to (6), it is burdensome for the monitor person that the monitor person is notified many times, such as when the person to be monitored comes to play in a predetermined range outside the school commuting time zone, so that the burden can be reduced, and the convenience of the monitor person is improved.

(7) In any one of the above (1) to (6), the notification unit may notify the terminal of the monitor person of the information about the person to be monitored including the image of the person to be monitored.

According to (7), the monitor person can remember who the monitor person should look at even when the monitor person forgets the person.

(8) In any one of the above (1) to (7), the terminal of the monitor person may display a mark that is capable of distinguishing the person to be monitored from another person when the person to be monitored is imaged.

According to (8), since the mark indicating the person to be monitored is displayed on the imaging screen of the first terminal at the time of imaging, the monitor person can easily monitor the person to be monitored.

(9) In any one of the above (1) to (7), the terminal of the monitor person may display the direction in which the person to be monitored is present on the screen on which the person to be monitored is imaged.

According to (9), even when the person to be monitored does not appear on the imaging screen at the time of imaging, the direction in which the person to be monitored is present displayed on the imaging screen of the first terminal, so that the monitor person can easily find the person to be monitored.

(10) A computer-readable non-transitory storage medium according to an aspect of the present invention stores a program causes a computer of a terminal having a communication function and an imaging unit to: acquire position information about the terminal; transmit the acquired position information to an external device; receive, from the external device, instruction information indicating that an identified person to be monitored approaches a predetermined range based on the acquired position information; present the received instruction information; and transmit an image captured by the imaging unit to the external device.

According to (10), the identifying person can grasp the situation of the person to be monitored through the image captured by the monitor person.

(11) In the above (10), the program may cause the computer to end the imaging unit after transmitting the image.

According to (11), it is possible to save the trouble of the operation by the monitor person. According to (11), even when the monitor person forgets ending the imaging unit, it is possible to prevent the person to be monitored from capturing the privacy space.

(12) In the above (10) or (11), the instruction information may include information indicating a capturable time range, and wherein the program may cause the computer to determine whether a current time falls within the capturable time range, and when the current time falls outside the capturable time range, not present the instruction information even when the instruction information is received.

According to (12), it is possible to save the trouble of repeatedly receiving a notification to the monitor person or capturing an image when the person to be monitored comes to play in a predetermined range at a time when it is out of the school commuting time zone.

According to (1) to (12), the monitor person can monitor the identified person to be monitored, and a monitoring result can be provided to the identifying person.

### BRIEF DESCRIPTION OF THE DRAWINGS

FIG. 1 is a diagram for describing an outline of a monitoring system according to the embodiment;

FIG. 2 is a diagram illustrating a configuration example of a monitoring system according to the first embodiment;

FIG. 3 is a diagram illustrating an example of person to be monitored information according to the first embodiment;

FIG. 4 is a diagram illustrating an example of monitor person information according to the first embodiment;

FIG. 5 is a diagram for explaining a school commuting route, a predetermined range, and the like;

FIG. 6 is a diagram illustrating an example of a notification screen and an example of an imaging screen;

FIG. 7 is a diagram illustrating another example of a screen at the time of notification and imaging;

FIG. 8 is a diagram illustrating an example of an image provided to an identifying person;

FIG. 9 is a sequence diagram of an example of a registration process performed when the monitoring system according to the first embodiment is used;

FIG. 10 is a sequence diagram of a monitoring process example according to the first embodiment;

FIG. 11 is a diagram illustrating a configuration example of a monitoring system according to the second embodiment; and

FIG. 12 is a sequence diagram of a monitoring process example according to the second embodiment.

### DETAILED DESCRIPTION OF THE INVENTION

Hereinafter, embodiments of the present invention will be described with reference to the drawings. In the drawings used in the following description, the scale of each member is appropriately changed in order to make each member recognizable in size.

In all the drawings for describing the embodiment, components having the same function are denoted by the same reference numbers, and repeated description is omitted.

As used herein, “on the basis of XX” and “based on XX” mean “on the basis of at least XX” and “based on at least XX”, and include “on the basis of another element in addition to XX” and “based on another element in addition to XX.” “On the basis of XX” and “based on XX” are not limited to a case where XX is directly used, and includes a case where calculation or processing is performed on XX. “XX” is arbitrary item (for example, arbitrary information).

(Outline of Monitoring System)

First, an outline of a monitoring system will be described.

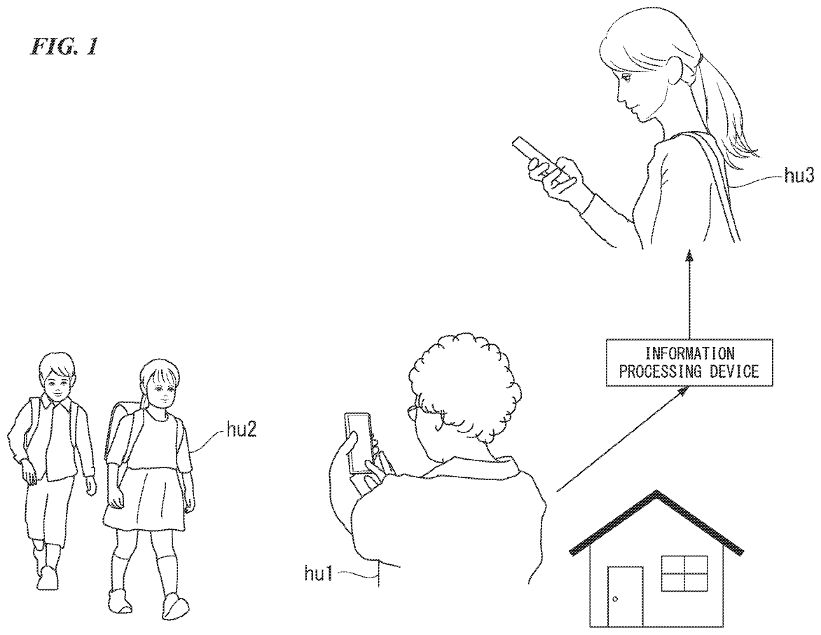

FIG. 1 is a diagram for describing an outline of a monitoring system according to the present embodiment. As illustrated in FIG. 1, in the present embodiment, when a person to be monitored hu2 falls within a predetermined range where a monitor person hu1 is present, the monitor person hu1 images the person to be monitored hu2. The information processing device provides the captured image to a person hu3 who identifies the person to be monitored. In the following description, a “person who identifies the person to be monitored” is referred to as an “identifying person”. The monitor person hu1 is, for example, an elderly person who is at home when a child goes to school. The person to be monitored hu2 is, for example, an elementary school student. The identifying person hu3 is, for example, the mother of the person to be monitored hu2. As described above, in the present embodiment, a person who performs watching is referred to as a monitor person. A person to be watched is referred to as a person to be monitored. The person to be monitored is not limited to a child, and may be an elderly person or the like.

In each of the following embodiments, in order to simplify the description, an example in which the number of the persons to be monitored, the number of the monitor persons, and the number of the persons who identifies the person to be monitored are each one described, but the present invention is not limited thereto. The number of the persons to be monitored and the number of the monitor persons each may be plural. For example, one person to be monitored may be monitored by a plurality of monitor persons. One monitor person may monitor a plurality of persons to be monitored. The person who can view the captured image is not limited to an identifying person. For example, the image can also be viewably provided to another person ((permitted person), for example, a father, a grandmother, a father, or the like) who are permitted, by an identifying person (for example, a mother), to share the viewing of the image.

### First Embodiment

### Configuration Example of Monitoring System

Next, a configuration example of a monitoring system 1 will be described.

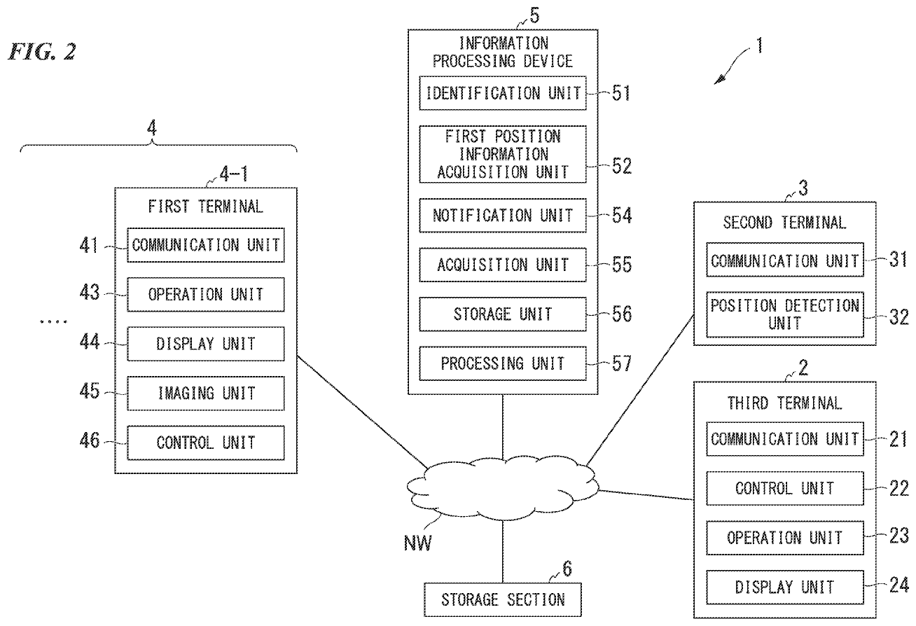

FIG. 2 is a diagram illustrating a configuration example of the monitoring system according to the present embodiment. As illustrated in FIG. 2, the monitoring system 1 includes a third terminal 2, a second terminal 3, a first terminal 4 (4-1, . . . ), an information processing device 5 (external device), and a storage section 6. In the following description, when one of “the first terminal 4-1, . . . ” is not identified, the terminal is referred to as the “first terminal 4”.

The third terminal 2, the second terminal 3, the first terminal 4, the information processing device 5, and the storage section 6 are connected via, for example, a wireless network NW.

The third terminal 2 includes, for example, a communication unit 21, a control unit 22, an operation unit 23, and a display unit 24.

The second terminal 3 includes, for example, a communication unit 31 and a position detection unit 32.

The first terminal 4 includes, for example, a communication unit 41 (communication function), an operation unit 43, a display unit 44, an imaging unit 45, a control unit 46, and a storage unit 47.

The information processing device 5 includes, for example, an identification unit 51, a first position information acquisition unit 52, a notification unit 54, an acquisition unit 55, a storage unit 56, and a processing unit 57.

First, the third terminal 2 will be described.

The third terminal 2 is any one of a smartphone, a tablet terminal, a personal computer, a dedicated terminal, and the like used by a person who identifies the person to be monitored. The third terminal 2 may include a storage unit and the like.

The communication unit 21 transmits and receives information to and from the information processing device 5 via a network NW.

The control unit 22 registers a person to be monitored, a school commuting route of the person to be monitored, a school commuting time zone (including day of week) of the person to be monitored, and the like on the basis of an operation result obtained by operating the operation unit. The registration is performed using, for example, an application provided by the information processing device 5.

The operation unit 23 is, for example, a touch panel sensor provided on the display unit 24.

The display unit 24 is, for example, a liquid crystal image display device, an organic electro luminescence (EL) image display device, or the like.

Next, the second terminal 3 will be described.

The second terminal 3 is a terminal possessed by the person to be monitored, and is, for example, any one of a smartphone, a dedicated terminal, and the like. The second terminal 3 may include a buzzer that sounds when asking for help or an operation button of the buzzer.

The communication unit 31 transmits and receives information to and from the information processing device 5 via the network NW.

The position detection unit 32 includes, for example, a global positioning system (GPS) receiving device, and detects the position of the second terminal 3 using the received information.

Next, the first terminal 4 will be described.

The first terminal 4 is a terminal possessed by a monitor person, and is, for example, any one of a smartphone, a tablet terminal, a dedicated terminal, and the like. The number of monitor persons may be plural, and in this case, each monitor person possesses the first terminal 4.

The communication unit 41 transmits and receives information to and from the information processing device 5 via the network NW. The communication unit 41 receives, for example, an application activation instruction, an application end instruction, a captured image transmission instruction, and the like from the information processing device 5.

The operation unit 43 is, for example, a touch panel sensor provided on the display unit 44.

The display unit 44 is, for example, a liquid crystal image display device, an organic electro luminescence (EL) image display device, or the like.

The imaging unit 45 is a camera, and captures an image in accordance with control of an application provided by the information processing device 5. The captured image is at least one of a still image, a plurality of still images, and a moving image. The image includes information indicating an imaging time and an imaging place.

In a case where an application activation instruction is received from the information processing device 5, the control unit 46 performs control to activate the application. In a case where an application end instruction is received from the information processing device 5, the control unit 46 performs control to terminate the application. In a case where an instruction to transmit a captured image is received from the information processing device 5, the control unit 46 performs control to transmit the captured image to the information processing device 5. The control unit 46 deletes the image temporarily stored in the storage unit 47 after transmission. The control unit 46 may transmit a captured image in response to a request from the information processing device 5.

The storage unit 47 stores an application provided from the information processing device 5. The storage unit 47 temporarily stores the captured image.

Next, the information processing device 5 will be described.

The information processing device 5 is an apparatus managed by a business operator that manages the entire monitoring system.

The identification unit 51 identifies the person to be monitored using the information received from the third terminal 2. The identification unit 51 stores information on the identified person to be monitored in the storage unit 56.

The first position information acquisition unit 52 acquires position information (first position information) of the person to be monitored from the second terminal 3.

The notification unit 54 detects that the person to be monitored has approached a predetermined range in which the monitor person stays, and notifies the terminal of the monitor person of the approach. For example, it is assumed that the monitor person stays in a pre-registered place (for example, a home address), and the notification unit 54 detects that the first position is in a predetermined range around the registered place.

The acquisition unit 55 acquires, from the third terminal 2, information on the identified person to be monitored during use of the monitoring service. The acquisition unit 55 acquires the monitor person information at the time of monitor person registration from the first terminal 4. The acquisition unit 55 acquires an image browsing request from the third terminal 2. The acquisition unit 55 acquires an image captured by the first terminal 4.

The storage unit 56 stores information received from each terminal. The storage unit 56 stores an application to be provided to each terminal.

The processing unit 57 detects the person to be monitored from the acquired image by a known image processing method. In a case where a plurality of persons appear in the captured image, the processing unit 57 performs an image process on an image of a person other than the person to be monitored so that the image cannot be recognized by means of mosaic processing or the like. The processing unit 57 stores the image in the storage section 6 so that the image can be provided to the identifying person who identifies the person to be monitored. The processing unit 57 may perform the above image process before saving or at the time of image provision. The processing unit 57 may delete the image stored in the storage section 6 in a predetermined period after storing the image, for example.

### Example of Person to be Monitored Information

Next, an example of the person to be monitored information will be described.

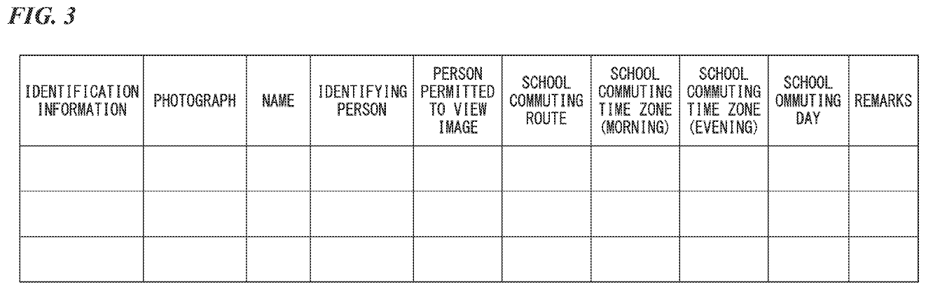

FIG. 3 is a diagram illustrating an example of the person to be monitored information according to the present embodiment. As illustrated in FIG. 3, in the person to be monitored information, for example, a photograph, a name, an identifying person, a school commuting route, a school commuting time zone (morning), a school commuting time zone (evening), a school commuting day, and remarks information of the person to be monitored are associated with the identification information. For example, when the school commuting time zone is different for each day of the week, the school commuting time zone is associated for each day of the week. The school commuting route and the school commuting time zone are not limited to those for the school but may include those for a cram school and a lesson. In this case, a plurality of school commuting routes and a plurality of school commuting time zones are associated with each other in one day for one person to be monitored.

The example illustrated in FIG. 3 is an example, and the person to be monitored information is not limited thereto. In the person to be monitored information, for example, the photograph may be updated every day by an identifying person, or clothes worn by the person to be monitored may be updated every day and associated as remark information. Height, features, and the like may be associated as the person to be monitored information. Furthermore, in a case where the person to be monitored is an elderly person or a patient, information such as a chronic disease, a store to be noted, and an emergency contact address may be associated in the person to be monitored information. In a case where the person to be monitored is an elderly person or a patient, the school commuting route is, for example, a visiting route to a hospital or a facility.

### Example of Monitor Person Information

Next, an example of the monitor person information will be described.

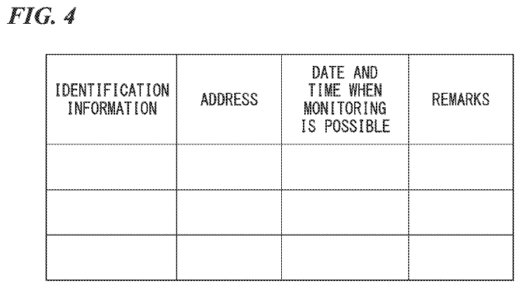

FIG. 4 is a diagram illustrating an example of monitor person information according to the present embodiment. As illustrated in FIG. 4, the monitor person information includes, for example, information such as identification information, an address, a monitorable date and time, and remarks of the monitor person.

The monitoring information illustrated in FIG. 4 is an example, and the present invention is not limited thereto.

(Notification to Monitor Person, Imaging)

Next, notification to a monitor person and imaging will be described.

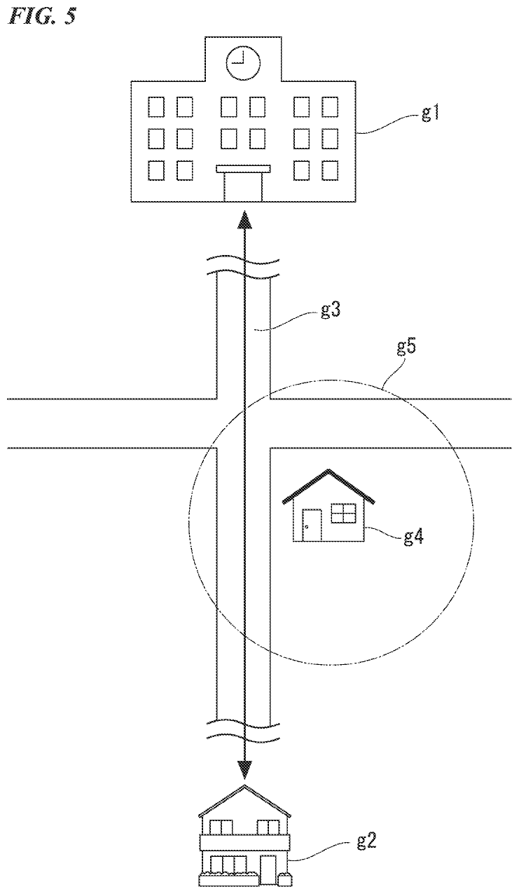

FIG. 5 is a diagram for describing a school commuting route, a predetermined range, and the like. In FIG. 5, a reference number g1 represents a position of a school, a reference number g2 represents a position of a house in which a person to be monitored lives, a reference number g3 represents a school commuting route, and a reference number g4 represents a position of a house in which a monitor person lives. A circle g5 indicates a predetermined range.

The information processing device 5 sets a predetermined range on the basis of the position of the monitor person's house, for example. Then, when the person to be monitored enters the predetermined range (circle g5), the fact is notified to the first terminal 4 used by the monitor person. The monitor person may operate an application, provided from the information processing device 5, installed in the first terminal 4 to transmit whether the monitor person stays at home on that day to the information processing device 5. Such input of the stay information about the monitor person may be performed before or after the notification.

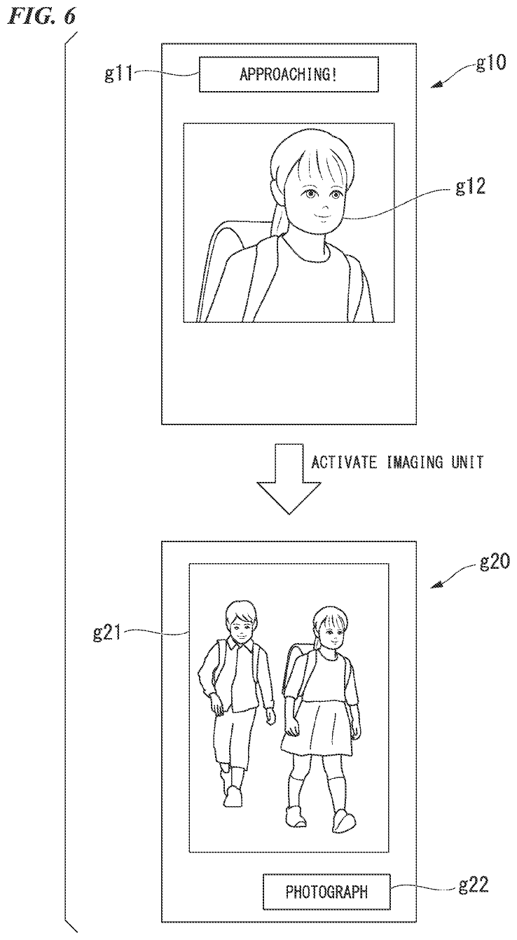

FIG. 6 is a diagram illustrating an example of a notification screen and an example of an imaging screen. An image g10 is an example of a notification screen displayed on the first terminal 4. An alert image g11 for making a notification that the person to be monitored is approaching and an image g12 of a person to be monitored are displayed on the notification screen. The notification may not include the person to be monitored image g12, but it is preferable to display the person to be monitored image g12 because the monitor person, who is, for example, an elderly person, may forget the person to be monitored. The person to be monitored image g12 is preferably an image captured by an identifying person before going to school because clothes are known. In a case where the person to be monitored is an elementary school student or the like, since the growth is fast, it is desirable that the identifying person periodically update the person to be monitored image g12. The predetermined range (range desired for monitoring) may be set by an identifying person.

An image g20 is an example of an imaging screen of the first terminal 4. In the present embodiment, the application installed in the first terminal 4 automatically activates the imaging unit 45 after displaying the notification screen of the image g10 for a predetermined time (for example, several seconds). The activation of the imaging unit 45 may be manually performed by a monitor person. The image g20 includes an image g21 to be captured and an imaging button image g22. The application may recognize the person to be monitored by a known method and automatically capture an image when the person to be monitored is recognized. For example, the application may control the zooming of the imaging unit 45 such that the image of the face of the person to be monitored has a predetermined size. As a result, even in a case where the monitor person captures an image from the house, it is easy for the identifying person to recognize the person to be monitored in the captured image.

The image example illustrated in FIG. 6 is an example, and the present invention is not limited thereto. For example, the image g20 may include an alert image g11.

When the person to be monitored moves outside the predetermined range, the application ends. Even when the person to be monitored is within the predetermined range, the information processing device 5 does not make a notification to the first terminal 4 when it is out of the set school commuting time zone. Alternatively, even when the person to be monitored is within the predetermined range, the application may not display the notification and may not activate the imaging unit 45 even if the application receives the notification when it is out of the set school commuting time zone.

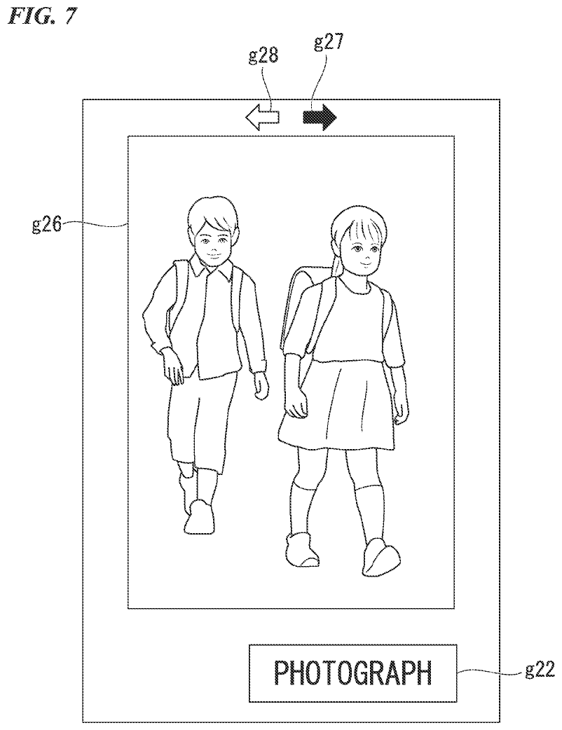

FIG. 7 is a diagram illustrating another example of a screen at the time of notification and imaging. The image displayed on the first terminal 4 of FIG. 7 is an image when the monitor person is about to image the person to be monitored after the imaging unit 45 is automatically activated or the monitor person manually activate the imaging unit 45 after the notification of the image g10 of FIG. 6 is received. Although the image of the person to be monitored is notified to the monitor person as in the image g10 in FIG. 6, the clothes are not necessarily matched, and it may be difficult for some monitor persons to memorize the image. Specifically, in a case where a plurality of children or the like goes to or from school in a group, children with similar clothes or children with similar faces may be present together.

In such a case, when a plurality of persons is captured, the first terminal 4 transmits information indicating a person corresponding to the person to be monitored, such as a black-filled arrow image g27, to the first terminal 4. The information processing device 5 transmits, to the first terminal 4, the information indicated by a no black-filled arrow g28 for a person who is not the person to be monitored. The notification of the person to be monitored and the others by the arrows g27 and g28 is an example, and the present invention is not limited thereto. The display method may be a mark capable of distinguishing the person to be monitored from the others, for example, a triangle mark or the like. For example, the first terminal 4 may present only the arrow g27 indicating only the person to be monitored.

Such notification of the person to be monitored and the others may be made by an application installed in the first terminal 4. In this case, the application may display an arrow or the like by performing image recognition (face recognition or the like) on the person to be monitored with respect to the image.

The notification of the person to be monitored and the others may be performed by the information processing device 5. For example, the information processing device sequentially acquires images acquired through the imaging unit 45. Then, the information processing device 5 may generate notification information on the basis of the position information detected by the second terminal 3 to transmit the generated notification information to the first terminal 4.

In FIG. 7, in a case where the person to be monitored does not appear on an imaging screen g26, the first terminal 4 may indicate which one of the left and right sides (or up and down, upper right, lower right, upper left, lower left) the person to be monitored is present by the arrow g27 on the basis of the notification information received from the information processing device 5. The shape and color of the mark indicating the direction in which the person to be monitored is present may be the same as or different from those of the arrows g27 and g28. Thus, the monitor person can know in which direction the person to be monitored is present. Accordingly, when the monitor person wants to know the position of the person to be monitored, the monitor person does not need to switch to the map screen to grasp the position of the person to be monitored when the imaging screen is activated, and can grasp the direction of the person to be monitored on the imaging screen. Specifically, in a case where the monitor person is an elderly person, few people can grasp the position of the person to be monitored by switching to the map screen when the imaging screen is activated. According to the present embodiment, such labor of the monitor person can be saved.

### Example of Image Provided to Identifying Person

Next, an example of an image provided to an identifying person will be described.

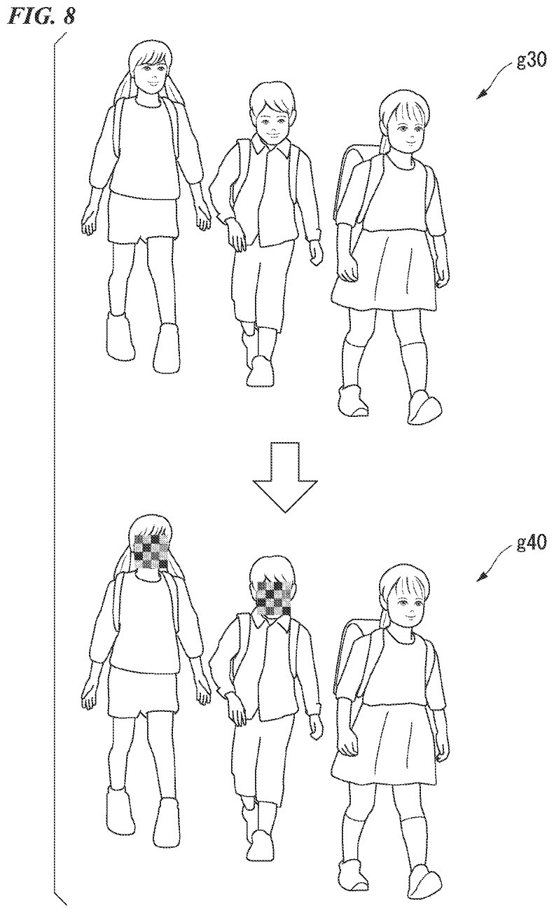

FIG. 8 is a diagram illustrating an example of an image provided to an identifying person. An image g30 is an image captured by the first terminal 4 of the monitor person. The image captured in this manner may include a person other than the person to be monitored at the time of going to school.

An image g40 is an example of an image provided to the person to be monitored and the identifying person. In a case where a person other than the person to be monitored is included in the image, the information processing device 5 performs a mosaic process on the faces of other persons such as the image g40 by the image process, thereby performing the image process to a level at which the image of the person other than the person to be monitored is not recognizable. With such an image process, privacy of other persons can be protected.

### Registration Process Example

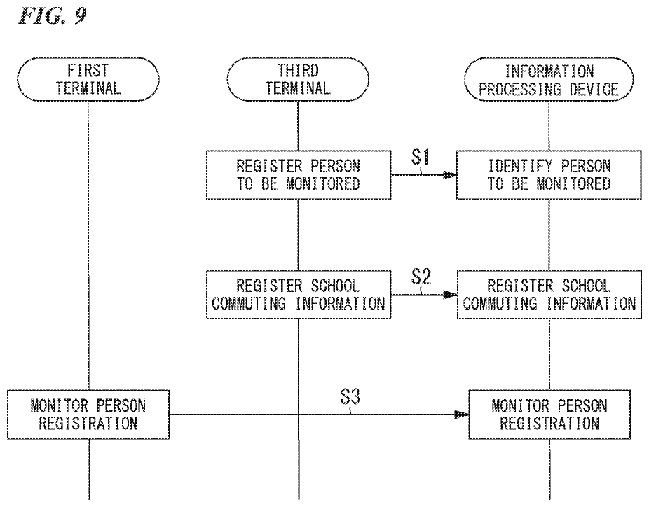

Next, an example of a registration process performed when the monitoring system 1 is used will be described. FIG. 9 is a sequence diagram of an example of a registration process performed when the monitoring system according to the present embodiment is used.

(Step S1) The third terminal 2 registers the person to be monitored according to an operation result operated by the identifying person who identifies the person to be monitored. The acquisition unit 55 of the information processing device 5 stores and registers the acquired information in the storage unit 56. For example, at the time of registration, the third terminal 2 transmits the image of the person to be monitored to the information processing device 5.

(Step S2) The third terminal 2 registers the person to be monitored going to school according to the operation result obtained by operating the person to be monitored by the identifying person. The acquisition unit 55 of the information processing device 5 stores and registers the acquired information in the storage unit 56. The school commuting information includes, for example, information such as a school commuting route, a school commuting time zone, and a school commuting day. In the case of registering the monitoring for a cram school or a lesson other than the school, the process of step S2 is repeated.

(Step S3) The first terminal 4 registers the monitor person according to the operation result obtained by the operation by the monitor person. The acquisition unit 55 of the information processing device 5 stores and registers the acquired information in the storage unit 56.

The processing procedure illustrated in FIG. 9 is an example, and the present invention is not limited thereto. For example, in a case where there is a plurality of persons to be monitored (for example, an older sister and a younger brother), the process of steps S1 and S2 is repeated for each person to be monitored. In a case where there is a plurality of monitor persons, the process of step S3 is repeated.

(Monitoring Process)

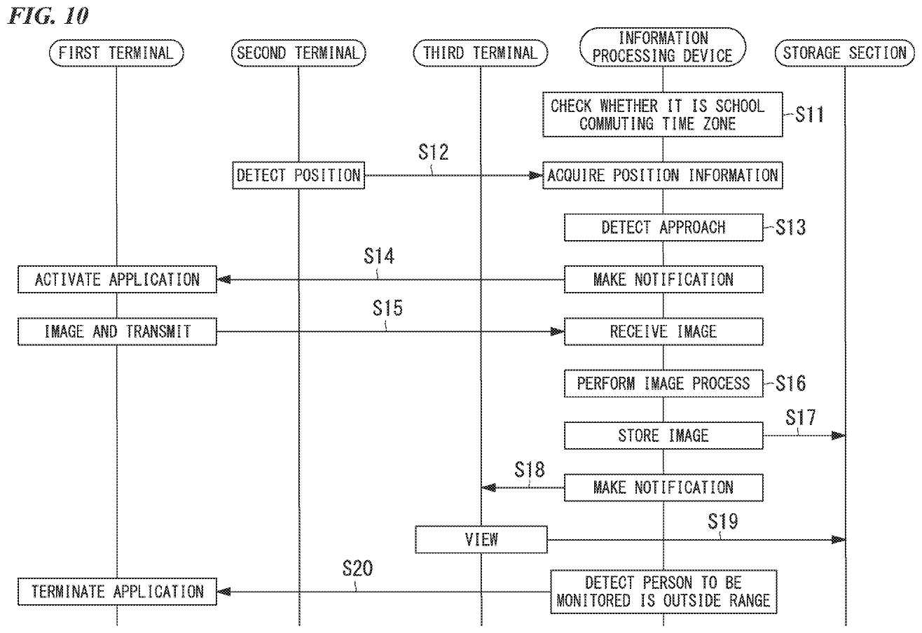

Next, a monitoring process example will be described. FIG. 10 is a sequence diagram of a monitoring process example according to the present embodiment.

(Step S11) The processing unit 57 of the information processing device 5 refers to the registered information and the current time to check whether it is the school commuting time zone. In a case where it is the school commuting time zone, the processing unit 57 proceeds to the process of step S12 and subsequent steps.

(Step S12) The position detection unit 32 of the second terminal 3 detects the position information (first position information) of the second terminal 3. The first position information acquisition unit 52 of the information processing device 5 acquires the first position information.

(Step S13) The notification unit 54 of the information processing device 5 sets a predetermined range on the basis of the position information about the monitor person stored in the storage unit 56. The notification unit 54 determines whether the position of the first position information is approaching the predetermined range.

(Step S14) When the position of the first position information enters the predetermined range, the notification unit 54 notifies the first terminal 4 of the position of the first position information. The control unit 46 of the first terminal 4 activates the installed application according to the received notification. Furthermore, the control unit 46 activates the imaging unit 45 according to the control of the application.

(Step S15) The imaging unit 45 performs imaging in accordance with an operation by a monitor person or in accordance with control of an application. The communication unit 41 of the first terminal 4 transmits the captured image to the information processing device 5. The acquisition unit 55 of the information processing device 5 acquires the captured image.

(Step S16) The processing unit 57 of the information processing device 5 performs an image process (recognition of the person to be monitored, mosaic processing on persons other than the person to be monitored, and the like) on the acquired image.

(Step S17) The processing unit 57 stores the monitor person information, the imaging date and time information, and the information such as the imaging place as well as the image in the storage section 6. The processing unit 57 may store the image before the image process in the storage section 6, or may store the image after the image process. In a case where the image before the image process is stored, the processing order of steps S16 and S17 is switched.

(Step S18) The notification unit 54 notifies the third terminal 2 of, for example, the Internet address at which the image of the person to be monitored can be viewed. The notification unit 54 may transmit the image-subjected to the image process to the third terminal 2.

(Step S19) The third terminal 2 views the image according to the operation by the identifying person.

(Step S20) In a case where it is detected that the person to be monitored is outside the predetermined range, the notification unit 54 notifies the first terminal 4 of the fact. The control unit 46 terminates the application in response to the notification.

The processing content and the processing procedure illustrated in FIG. 10 are examples, and the present invention is not limited thereto. Some processes may be performed simultaneously, and the processing procedures of some processes may be interchanged.

The notification (instruction) to the monitor person may include a capturable time range. The capturable time range is a school commuting time zone. In this case, the application installed in the first terminal 4 of the monitor person may determine whether the current time is within the capturable time range, and may not present the notification (instruction information) even if the notification (instruction information) is received when the current time is outside the capturable time range.

### Example of Application

Here, an example of an application provided by the information processing device 5 will be described.

The first application is provided to the first terminal 4 used by the monitor person. The first application performs registration of a monitor person, reception and presentation of a notification when the person to be monitored is within a predetermined range, activation of the imaging unit 45, and the like.

The second application is an application provided to the third terminal 2 used by the identifying person. The second application performs registration of an identifying person, registration of the person to be monitored information, viewing of a captured image, and the like.

The above-described processing example of the application is an example, and the present invention is not limited thereto.

As described above, in the present embodiment, the person to be monitored is identified and notified to the monitor person. In the present embodiment, when a position of the person to be monitored falls within the predetermined range with respect to the position of the monitor person, the first terminal 4 possessed by the monitor person is notified of the position of the person to be monitored. Then, in the present embodiment, the application provided by the information processing device 5 is activated in response to the notification, and the imaging unit 45 is further activated in response to the notification. Furthermore, in the present embodiment, the application is terminated when the position of the person to be monitored is outside the predetermined range with respect to the position of the monitor person. In the present embodiment, the image captured by the first terminal 4 is provided to the identifying person. In the present embodiment, the notification is not given to the monitor person in a case where the person to be monitored is in a predetermined range at a time when it is out of the school commuting time zone. In the present embodiment, in a case where another person other than the person to be monitored is included in the image, mosaic processing or the like is performed on the image of the another person to provide the image to the identifying person. In the present embodiment, a person who is permitted, by an identifying person, to view the image can also view the image. In the present embodiment, the notification to the monitor person includes the image of the person to be monitored. In the present embodiment, the mark indicating the person to be monitored is displayed on the imaging screen of the first terminal 4 at the time of imaging. In the present embodiment, the terminal 4 of the monitor person displays the direction in which the person to be monitored is present on the screen on which the person to be monitored is imaged.

Thus, according to the present embodiment, the identifying person can grasp the situation of the person to be monitored through the image captured by the monitor person. According to the present embodiment, it is possible to save the trouble of repeatedly receiving a notification to the monitor person or capturing an image, for example, when the person to be monitored comes to play in a predetermined range at a time when it is out of the school commuting time zone. According to the present embodiment, it is possible to protect privacy of persons other than the person to be monitored. According to the present embodiment, for example, a grandfather, a grandmother, and the like can view the image, and thus it is possible to confirm the image, for example, when the identifying person is absent. According to the present embodiment, the monitor person can remember who the monitor person should look at even when the monitor person forgets the person. According to the present embodiment, it is possible to save the trouble of the operation by the monitor person, and it is possible to prevent the person to be monitored from capturing the privacy space even when the monitor person forgets ending the imaging unit 45. According to the present embodiment, since the mark indicating the person to be monitored is displayed on the imaging screen of the first terminal 4 at the time of imaging, the monitor person can easily monitor the person to be monitored. According to the present embodiment, even when the person to be monitored does not appear on the imaging screen at the time of imaging, the direction in which the person to be monitored is present displayed on the imaging screen of the first terminal 4, so that the monitor person can easily find the person to be monitored.

### Second Embodiment

(Configuration Example of Monitoring System)

Next, a configuration example of a monitoring system 1 will be described.

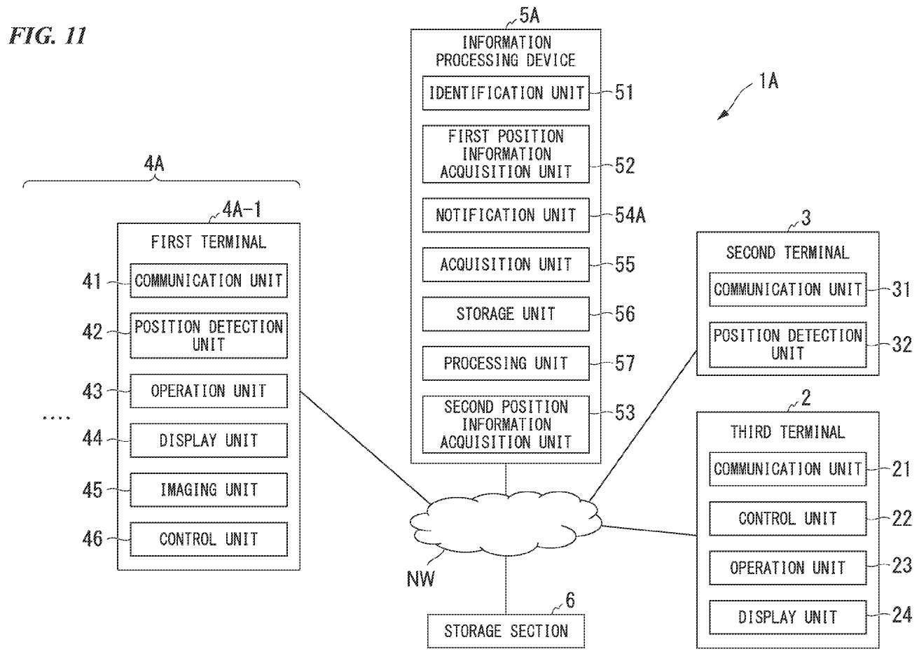

FIG. 11 is a diagram illustrating a configuration example of the monitoring system according to the present embodiment. As illustrated in FIG. 11, a monitoring system 1A includes the third terminal 2, the second terminal 3, first terminal 4A (4A-1, . . . ), an information processing device 5A, and the storage section 6.

The third terminal 2, the second terminal 3, the first terminal 4A, the information processing device 5A, and the storage section 6 are connected via, for example, the wireless network NW.

The third terminal 2 includes, for example, a communication unit 21, a control unit 22, an operation unit 23, and a display unit 24.

The second terminal 3 includes, for example, a communication unit 31 and a position detection unit 32.

The first terminal 4A includes, for example, the communication unit 41, a position detection unit 42, the operation unit 43, the display unit 44, the imaging unit 45, the control unit 46, and the storage unit 47.

The information processing device 5A includes, for example, the identification unit 51, the first position information acquisition unit 52, a second position information acquisition unit 53, a notification unit 54A, the acquisition unit 55, the storage unit 56, and the processing unit 57.

The position detection unit 42 of the first terminal 4A includes, for example, a global positioning system (GPS) receiving device, and detects the position of the second terminal 3 using the received information.

The second position information acquisition unit 53 of the information processing device 5A acquires the position information (second position information) of the monitor person from the first terminal 4.

The notification unit 54A detects that the person to be monitored has approached a predetermined range in which the monitor person is present on the basis of the acquired the first position information and the second position information, and notifies the terminal of the monitor person of the approach.

(Monitoring Process)

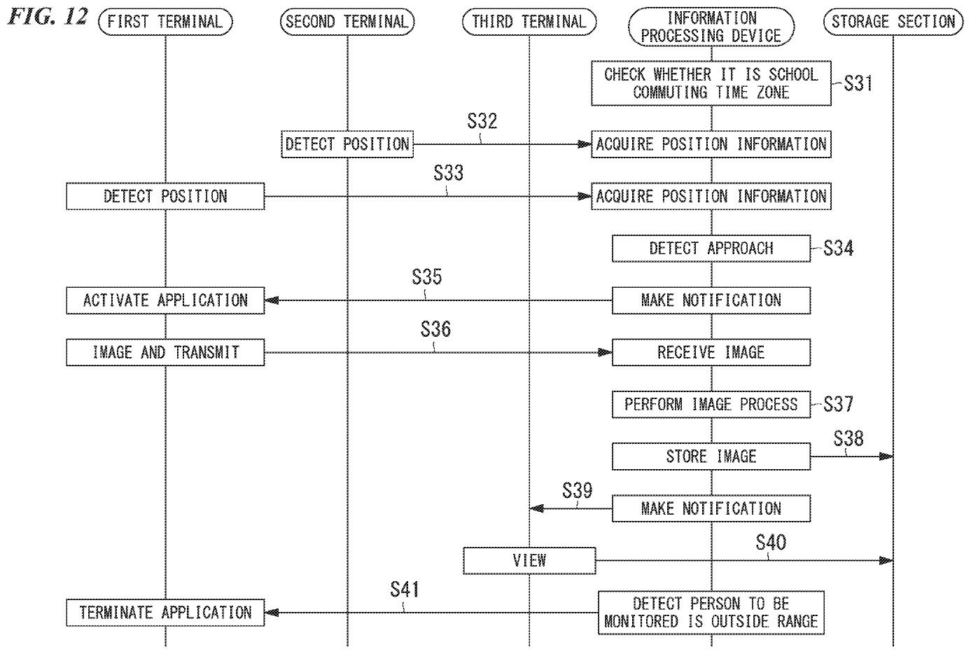

Next, a monitoring process example will be described. FIG. 12 is a sequence diagram of a monitoring process example according to the present embodiment. The registration processing procedure is similar to that of the first embodiment.

(Step S31) The processing unit 57 of the information processing device 5A refers to the registered information and the current time to check whether it is the school commuting time zone. In a case where it is the school commuting time zone, the processing unit 57 proceeds to the process of step S32 and subsequent steps.

(Step S32) The position detection unit 32 of the second terminal 3 detects the position information (first position information) of the second terminal 3. The first position information acquisition unit 52 of the information processing device 5A acquires the first position information.

(Step S33) The position detection unit 42 of the first terminal 4 detects the position information (second position information) of the first terminal 4A. The second position information acquisition unit 53 of the information processing device 5A acquires the second position information.

(Step S34) The notification unit 54A of the information processing device 5A sets the predetermined range on the basis of the acquired second position information. The notification unit 54A determines whether the position of the first position information is approaching a predetermined range.

(Step S35) When the position of the first position information enters the predetermined range, the notification unit 54A notifies the first terminal 4A of the position of the first position information. The control unit 46 of the first terminal 4A activates the installed application according to the received notification. Furthermore, the control unit 46 activates the imaging unit 45 according to the control of the application. The notification unit 54A may set the predetermined range on the basis of the address registered by the monitor person. The notification unit 54A may not make a notification to the monitor person in a case where the monitor person is not within the predetermined range on the basis of the second position information.

(Step S36) The imaging unit 45 performs imaging in accordance with an operation by a monitor person or in accordance with control of an application. The communication unit 41 of the first terminal 4A transmits the captured image to the information processing device 5A. The acquisition unit 55 of the information processing device 5A acquires the captured image.

(Step S37) The processing unit 57 of the information processing device 5A performs an image process (recognition of the person to be monitored, mosaic processing on persons other than the person to be monitored, and the like) on the acquired image.

(Step S38) The processing unit 57 stores the image in storage section 6. The processing unit 57 may store the image before the image process in the storage section 6, or may store the image after the image process. In a case where the image before the image process is stored, the processing order of steps S37 and S38 is switched.

(Step S39) The notification unit 54A notifies the third terminal 2 of, for example, the Internet address at which the image of the person to be monitored can be viewed. The notification unit 54A may transmit the image subjected to the image process to the third terminal 2.

(Step S40) The third terminal 2 views the image according to the operation by the identifying person.

(Step S41) In a case where it is detected that the person to be monitored is outside the predetermined range, the notification unit 54A notifies the first terminal 4A of the fact. The control unit 46 terminates the application in response to the notification.

The processing content and the processing procedure illustrated in FIG. 12 are examples, and the present invention is not limited thereto. Some processes may be performed simultaneously, and the processing procedures of some processes may be interchanged.

As described above, in the present embodiment, in addition to the first embodiment, in a case where the monitor person is not within the predetermined range, the notification is not given to the monitor person.

As a result, according to the present embodiment, since the notification is not received when the monitor person is not in the predetermined range, it is not troublesome for the monitor person.

A program for realizing all or part of the functions of the first terminal 4 (or 4A), the second terminal 3, the third terminal 2, and the information processing device 5 (or 5A) in the present invention may be recorded in a computer-readable recording medium, and the program recorded in the recording medium may be read and executed by a computer system to perform all or part of the processing performed by the first terminal 4 (or 4A), the second terminal 3, the third terminal 2, and the information processing device 5 (or 5A). The “computer system” herein includes an OS and hardware such as peripheral devices. The “computer system” includes a WWW system having a website providing environment (or a display environment). The “computer-readable recording medium” refers to a portable medium such as a flexible disk, a magneto-optical disk, a ROM, or a CD-ROM, or a storage device such as a hard disk built in a computer system. Furthermore, the “computer-readable recording medium” includes a medium that holds a program for a certain period of time, such as a volatile memory (RAM) inside a computer system that serves as a server or a client when the program is transmitted via a network such as the Internet or a communication line such as a telephone line.

The program may be transmitted from a computer system in which the program is stored in a storage device or the like to another computer system via a transmission medium or by a transmission wave in the transmission medium. Here, the “transmission medium” for transmitting a program refers to a medium having a function of transmitting information, such as a network (communication network) such as the Internet or a communication line (communication line) such as a telephone line. The program may be for realizing part of the functions described above. Furthermore, it may be for realizing the above-described function by a combination with a program already recorded in the computer system, that is, a so-called difference file (difference program).

The modes for carrying out the present invention have been described above using the embodiments, but the present invention is not limited to the embodiments described above, and various modifications and substitutions are possible without departing from the gist of the present invention.

What is claimed is:

1. A monitoring system comprising:
an identification unit configured to identify a person to be monitored;
a first position information acquisition unit configured to acquire position information about the person to be monitored;
a notification unit configured to detect that the person to be monitored enters a predetermined range and notify a terminal of a monitor person of the person to be monitored entering the predetermined range;
a data storage section configured to store an image of the person to be monitored captured within the predetermined range with the terminal by the monitor person who receives the notification so as to be capable of providing to an identifying person who identifies the person to be monitored; and
a processing unit capable of providing an image of the person to be monitored to the identifying person who identifies the person to be monitored.

2. The monitoring system according to claim 1, wherein
the processing unit is capable of providing an image of the person to be monitored to a permitted person who is permitted, by the identifying person, to share a situation of the person to be monitored.

3. The monitoring system according to claim 1, further comprising:
a second position information acquisition unit configured to acquire position information about the monitor person, wherein
the notification unit does not make a notification to the terminal of the monitor person when the monitor person does not stay in the predetermined range on the basis of a result acquired by the second position information acquisition unit.

4. The monitoring system according to claim 1, wherein
the monitoring system does not make a notification to the terminal of the monitor person when the person to be monitored does not stay in the predetermined range.

5. The monitoring system according to claim 1, wherein
the processing unit performs an image process on the image to a level at which an image of a person other than the person to be monitored is not recognizable, and provides the image to the identifying person.

6. The monitoring system according to claim 1, wherein
the notification unit does not make a notification to the terminal of the monitor person in a time other than a predetermined time even when the person to be monitored is in the predetermined range.

7. The monitoring system according to claim 1, wherein
the notification unit notifies the terminal of the monitor person of information about the person to be monitored including an image of the person to be monitored.

8. The monitoring system according to claim 1, wherein
the terminal of the monitor person displays a mark that is capable of distinguishing the person to be monitored from another person when the person to be monitored is imaged.

9. The monitoring system according to claim 1, wherein
the terminal of the monitor person displays a direction in which the person to be monitored is present on a screen on which the person to be monitored is imaged.

10. A computer-readable non-transitory storage medium storing a program causing a computer of a terminal having a communication function and an imaging unit to:
acquire position information about the terminal;
transmit the acquired position information to an external device;
receive, from the external device, instruction information indicating that an identified person to be monitored approaches a predetermined range based on the acquired position information;
present the received instruction information;
activate an imaging unit on the basis of the received information; and
transmit an image captured by the imaging unit to the external device.

11. The storage medium according to claim 10, wherein
the program causes the computer to:
end the imaging unit after transmitting the image.

12. The storage medium according to claim 10, wherein
the instruction information includes information indicating a capturable time range, and
the program causes the computer to:
determine whether a current time falls within the capturable time range, and when the current time falls outside the capturable time range, not present the instruction information even when the instruction information is received.
